(19) United States
(12) Patent Application Publication
(10) Pub. No.: US 2011/0068742 A1
(43) Pub. Date: Mar. 24, 2011

(54) AUDIO DEVICE THAT INTERFACES WITH A BATTERY CHARGER

(76) Inventors: Ronald C. McCurry, West Union, SC (US); Wolf Mueller, Simpsonville, SC (US); Jeffrey N. Cutler, Anderson, SC (US); Mike Hornick, Anderson, SC (US); Jonathan A. Zick, Waukesha, WI (US); Scott D. Bublitz, Hartland, WI (US); Melissa A. Ottens-Rendon, Waukesha, WI (US)

(21) Appl. No.: 12/768,495

(22) Filed: Apr. 27, 2010

Related U.S. Application Data
(63) Continuation-in-part of application No. 12/605,482, filed on Oct. 26, 2009, now Pat. No. 7,868,590.
Application No. 12/605,482 is a continuation of application No. 10/926,744, filed on Aug. 26, 2004, now Pat. No. 7,609,027.
Application No. 10/926,744 is a continuation-in-part of application No. 10/291,868, filed on Nov. 8, 2002, now Pat. No. 6,982,541.
(60) Provisional application No. 60/379,068, filed on May 9, 2002.
(60) Provisional application No. 60/344,431, filed on Nov. 9, 2001.
(60) Provisional application No. 60/523,541, filed on Nov. 19, 2003.
(60) Provisional application No. 60/540,313, filed on Jan. 28, 2004.

(51) Int. Cl. H02J 7/00

(52) U.S. Cl. 320/114; 320/137

(57) ABSTRACT

Audio devices powered by rechargeable batteries or an external power source including a separate audio device housing and battery charger housing that are engageable with each other. The audio device housing and battery charger housing can share an external power source. Furthermore, when separated, the audio device housing and battery charger housing are usable alone to produce sound and to charge a battery, respectively. In some instances, a battery placed in a first position is charged and, when placed in a second position, provides power to the audio circuit.

### RELATED APPLICATIONS

This application is a continuation-in-part application of co-pending patent application Ser. No. 12/605,482, filed Oct. 26, 2009, which is a continuation of patent application Ser. No. 10/926,744, filed on Aug. 26, 2004, now U.S. Pat. No. 7,609,027, which is a continuation-in-part of patent application Ser. No. 10/291,868, filed Nov. 8, 2002, now U.S. Pat. No. 6,982,541, which claims the benefit of Provisional Patent Application Ser. No. 60/379,068, filed May 9, 2002 and Provisional Patent Application Ser. No. 60/344,431, filed on Nov. 9, 2001. patent application Ser. No. 10/926,744 also claims the benefit of Provisional Patent Application Ser. No. 60/523,541, filed Nov. 19, 2003, and Provisional Patent Application Ser. No. 60/540,313, filed Jan. 28, 2004. The entire contents of all of the above applications are hereby incorporated by reference.

### BACKGROUND

The invention relates to audio devices that are operable with rechargeable batteries.

Audio devices that output audio signals, such as radios, compact disc players, mp3 players, and the like, use a power supply to provide power for an audio circuit capable of outputting the audio signals. Some audio devices connect to a fixed AC power supply, such as a 120 Volt, 60 Hz outlet in a building. Other audio devices use a battery power supply and in some cases rechargeable batteries to power an audio circuit.

Rechargeable power tool batteries are frequently available on a construction and other jobsite. These power tool batteries can be interchangeably used by different types of power tools including, for example, drills and screwdrivers. Audio devices (e.g., jobsite radios) have been developed that can also be powered by these rechargeable power tool batteries.

### SUMMARY

In one embodiment, the invention provides an audio system including a battery charger housing and an audio device housing that are selectively engagable. The battery charger housing includes a charger control circuit and a first rechargeable battery receptacle having a first battery position. The charger control circuit is electrically coupled to the first rechargeable battery receptacle and is operable to charge a battery in the first battery position within the first rechargeable battery receptacle.

The audio device housing includes an audio circuit and a second rechargeable battery receptacle. The audio circuit is electrically coupled to the second rechargeable battery receptacle and is operable to generate sound using at least one audio generator. A pass-through circuit is electrically coupled to the audio circuit and to the first battery position. The pass-through circuit is operable to receive power from an external source, provide the power to the charger control circuit, and provide the power to the audio circuit.

In another embodiment, the invention provides an audio system including a battery charger housing and an audio device housing that are selectively engageable. The battery charger housing includes a battery charger housing having a charger control circuit and a first battery receptacle operable to receive a first removable battery. The charger control circuit is electrically coupled to the first battery receptacle to charge the first battery when in a first battery position within the first battery receptacle.

The audio device housing includes an audio circuit and a second battery receptacle. The audio circuit is electrically coupled to the second battery receptacle and is operable to generate sound using at least one audio generator. The audio circuit is also operable to at least one of combine and selectively apply power received from a second removable battery within the second battery receptacle and power received from an external power source to the at least one audio generator.

In another embodiment, the invention provides an audio system including a battery charger housing and an audio device housing. The battery charger housing includes a charger control circuit and a first battery receptacle. The charger control circuit is coupled to a first electrical connection in the first battery receptacle and is operable to charge a first removable battery in the first battery position.

The audio device housing is engageable with the battery charger housing and includes an audio circuit and a second battery receptacle. The audio circuit is electrically coupled to the second battery receptacle and operable to generate sound using at least one audio generator. The audio circuit is operable to selectively couple the at least one audio generator to the second battery receptacle and an input configured to receive power from an external source. When the battery charger housing is engaged with the audio device housing and the power is received at the input from the external source, the charger control circuit and the audio circuit share the power received from the external source.

In another embodiment, the invention includes a method of charging a battery and generating audio. The method includes operating an audio housing in a first mode, and at least one of a second mode and a third mode. The first mode includes coupling a battery charger housing to the audio housing. The battery charger housing includes a first battery receptacle and a charging circuit and the audio housing includes an audio generating circuit and a second battery receptacle. The first mode also includes coupling the battery charger housing to an external power source using a cord such that an electrical connection is formed between the external power source, the charging circuit, and the audio generating circuit. The first mode further includes charging a first battery in a first position in the first battery receptacle and generating audio using the audio generating circuit powered by the external power source.

The second mode includes disconnecting at least one of the cord from the battery charger housing and the battery charger housing from the audio housing and generating audio using the audio generating circuit powered by a second battery in the second battery receptacle.

The third mode includes disconnecting at least one of the cord from the battery charger housing and the battery charger housing from the audio housing; coupling the external power source or a different external power source to the audio housing; and generating audio using the audio generating circuit powered by the external power source or the different external power source.

In some embodiments, the method includes operating the audio housing in a fourth mode. The fourth mode includes placing the first battery in a second position within the first battery receptacle, and generating audio using the audio generating circuit powered by the first battery in the second position.

In some embodiments of the method, the audio housing includes one of a fixed cord and a selectively removable cord, and the battery charger housing includes one of a fixed cord and a selectively removable cord.

Other aspects of the invention will become apparent by consideration of the detailed description and accompanying drawings.

### BRIEF DESCRIPTION OF THE DRAWINGS

FIG. 1 is a schematic diagram of an audio device according to embodiments of the invention.

FIG. 2 is a schematic diagram of an audio circuit according to embodiments of the invention.

FIGS. 3-6 illustrate an audio housing, battery charger housing, and cords according to embodiments of the invention.

FIG. 7 is a schematic diagram of an audio device according to embodiments of the invention.

FIGS. 8-11 illustrate an audio housing, battery charger housing, and cords according to embodiments of the invention.

FIG. 12 is a schematic diagram of an audio device according to embodiments of the invention.

FIG. 13 is a schematic diagram of an audio device according to embodiments of the invention.

FIG. 14 is a schematic diagram of an audio device according to embodiments of the invention.

FIG. 15 is a schematic diagram of an audio device according to embodiments of the invention.

FIGS. 16 and 17A-B illustrate an audio housing, battery charger housing, and cords according to embodiments of the invention.

FIGS. 18A-B are a schematic diagram of an audio device according to embodiments of the invention.

FIG. 19 is a schematic diagram of an audio device according to embodiments of the invention.

FIG. 20 is a schematic diagram of an audio device according to embodiments of the invention.

FIG. 21 is a schematic diagram of an audio device according to embodiments of the invention.

FIG. 22 is a schematic diagram of an audio device according to embodiments of the invention.

FIG. 23 is a schematic diagram of an audio device according to embodiments of the invention.

FIG. 24 depicts a first mode of operating an audio system according to embodiments of the invention.

FIG. 25 depicts a second mode of operating an audio system according to embodiments of the invention.

FIG. 26 depicts a third mode of operating an audio system according to embodiments of the invention.

FIG. 27 depicts a fourth mode of operating an audio system according to embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Although audio devices (e.g., jobsite radios) have been developed that are powered by rechargeable power tool batteries, the batteries eventually lose their charge and the audio device will not function until a new battery is inserted or the audio device is connected to an external power source. As is explained in more detail below, embodiments of the invention provide unique and improved systems and methods of selectively attaching a battery charger housing with an audio device.

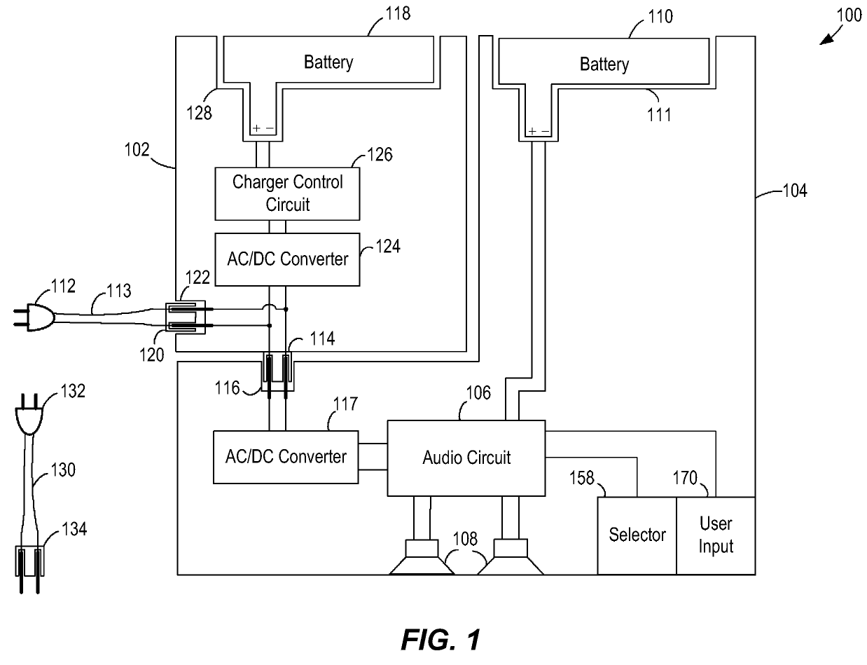

FIG. 1 depicts an audio system 100 according to one embodiment of the invention. The audio system 100 includes a battery charger housing 102 and an audio housing 104. The audio housing 104 includes an audio circuit 106 and speakers 108 for generating and outputting sound, such as music or audio books. The audio housing 104 also includes selector 158 and user input 170, which will be described in greater detail below. The audio circuit 106 receives power from at least one of two sources: 1) a rechargeable battery 110 coupled to the audio housing 104 and 2) an external power source coupled to the battery charger housing 102 via cord 113. An AC/DC converter 117 is provided between the audio circuit 106 and socket 116. The AC/DC converter 117 converts alternating current received from an external power source via socket 116 and outputs direct current to the audio circuit 106. An exemplary external power source is a 120 volt, 60 hertz wall outlet typically found in homes and businesses. Other external power sources, including those with different voltage types and ratings such as a 12-volt DC car battery, may also be used.

The battery charger housing 102 is electrically coupled to the audio housing 104 via a plug 114 and socket 116 connection. In some embodiments, the plug 114 is part of the audio housing 104 and the socket 116 is part of the battery charger housing 102. The battery charger housing 102 receives power from the external power source via cord 113 and uses the power to charge a battery 118. The cord 113 with plug 112 is coupled to the battery charger housing 102 by plug 120 and socket 122 (i.e., a male-female connection). In some embodiments, the plug 120 is part of the battery charger housing 102 and the socket 122 is part of cord 113. In some embodiments, connection techniques other than the depicted plug and socket connection are used to couple the audio housing 104 and battery charger housing 102.

The battery charger housing 102 includes an AC/DC converter 124, a charger control circuit 126, and a battery receptacle 128. The battery receptacle 128 receives and is electrically coupled to the battery 118. Alternating current from the external source is received by the AC/DC converter 124, which converts the alternating current and outputs direct current to the charger control circuit 126. The charger control circuit 126 outputs DC voltage and charges battery 118.

Thus, the external power source provides power to both charge the battery 118 and power the audio circuit 106. The electrical connections within the audio and battery housing, including the socket 122, plug 114, and socket 116, that enable external power to reach the audio circuit 106, and AC/DC converters 117 and 124 may be referred to as a pass-through circuit. Unlike the battery 110, the battery 118 does not provide power to the audio circuit 106. In other embodiments, however, additional electrical connections are provided such that battery 118 provides power to the audio circuit 106. Batteries 110 and 118 can be lithium-based, nickel-based, or any other rechargeable battery chemistry suitable to power audio system 100.

The battery charger housing 102 is removable from the audio housing 104 and each is usable independent of the other. In other words, when separated, the battery charger housing 102 still functions to charge the battery 118 and the audio housing 104 still functions to generate audio. When separated, the audio housing 104 can receive power from either the battery 110 or by an external power source providing power via socket 116. An additional cord 130 includes plugs 132 and 134 and is similar to cord 113. When the battery charger housing 102 is separated from the audio housing 104, plug 134 can be coupled to the socket 116 and provide power to the audio circuit 106 by connecting plug 132 to the external power source. Cords 130 and 113 are interchangeable between the audio housing 104 and the battery charger housing 102.

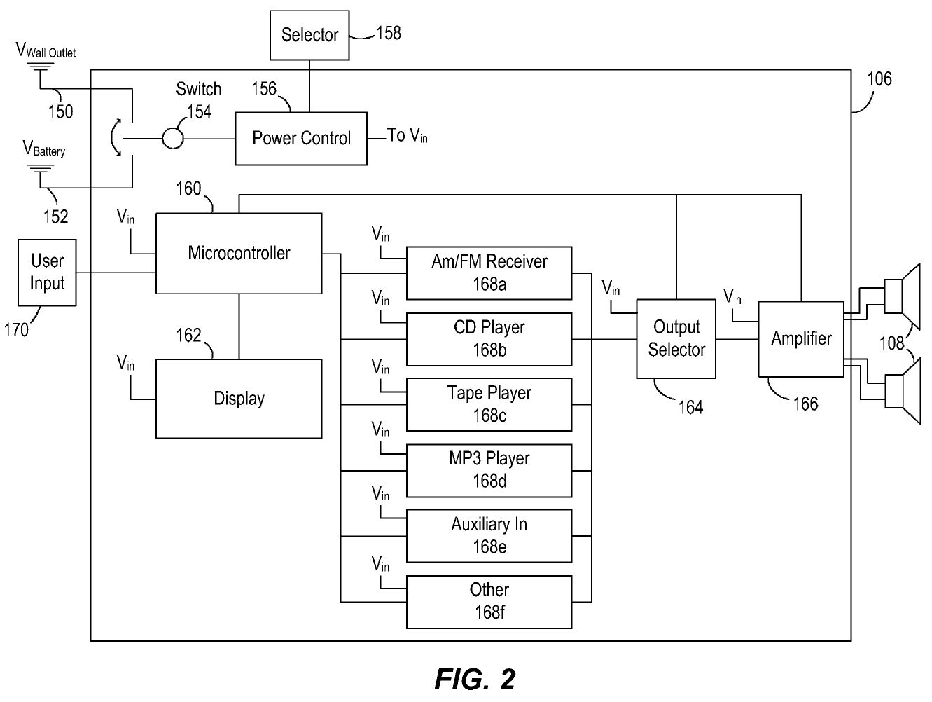

FIG. 2 depicts the audio circuit 106 according to one embodiment of the invention. Power provided by the external power source via socket 116 is supplied along power line 150. Power provided by battery 110 is supplied along power line 152. A switch 154, controlled by power control 156, is configured to selectively couple either power line 150 or power line 152 to power control 156, which outputs DC voltage Vᵢₙ. When power control 156 is coupled to power lines 150 or 152, the DC voltage is passed-through or modified (stepped-up or stepped-down) to Vᵢₙ. Vᵢₙ is a direct current voltage appropriate for the components of the audio circuit 106. For instance, Vᵢₙ can be 5V or 3.3V. In other embodiments, some of the components of audio circuit 106 require different voltage inputs. For instance, Vᵢₙ is 5V for some components (e.g., the microcontroller 160) but 3.3V for other components (e.g., output selector 164). In some embodiments, DC voltage of the battery 110 is supplied to the audio circuit 106 and no AC/DC conversion hardware is provided within the audio circuit. In some embodiments, the AC/DC converter 117 is located within the audio circuit 106. Thus, the power control 156 selectively applies DC power from power lines 150 or 152 to the components of audio circuit 106.

In some embodiments, the power control 156 controls the switch 154 to supply power from the power line 150 when the power control 156 detects that the socket 116 is coupled to an external power supply and to provide power from the battery 110 when no external power supply is available. Is some embodiments, the power control 156 controls the switch 154 based on input from selector 158. The selector 158 is a pushbutton, sliding actuator, or other similarly functioning device, that enables a user to selectively choose between the battery 110 power or the external power provided through socket 116. In some embodiments, the audio circuit 106 does not include a switch 154. Rather, the power control 156 receives power from both power lines 150 and 152 and combines the power input by both to output Vᵢₙ. In these embodiments, the battery 110 is not charged by the external source. In other embodiments, the battery 110 is charged by the external source while inserted in the battery receptacle 111.

The exemplary audio circuit 106 of FIG. 2 also includes a microcontroller 160, display 162, output selector 164, amplifier 166, and several audio generators 168a-f. The microcontroller 160 includes software, hardware, or a combination thereof to control the display 162, output selector 164, and audio generators 168a-f. In one embodiment, the microcontroller controls the display 162 to display the current audio generator 168a-f selection and other status information. For instance, if the audio circuit 106 is set to AM radio station 1000, the display may show “AM 1000.” Other appropriate status information may be displayed as is apparent to one of ordinary skill in the art.

The microcontroller 160 receives input from user input 170. User input 170 can include an audio generator selector such as one or more push buttons to control which audio generator 168a-f is currently active. Additional user input 170 can include selectors to control the operation of particular audio generators, such as, for instance, controls for playing, stopping, fast forwarding, or rewinding a compact disc, tape, or other media. Other appropriate controls for audio generators 168a-f may be included as is apparent to one of ordinary skill in the art.

Upon receipt of input from user input 170, the microcontroller 160 enables one of the audio generators 168a-f and controls the output selector 164 to connect the output from the selected audio generator 168a-f to the input of amplifier 166. The amplifier 166 amplifies the audio signals received from the selected audio generator by an amount specified by a user via user input 170 and microcontroller 160. The amplifier 166 outputs the amplified audio signal to speakers 108.

Audio circuit 106 is merely an exemplary audio circuit used in some embodiments of the invention. In some embodiments, other audio circuits are used to generate audio signals for speakers 108.

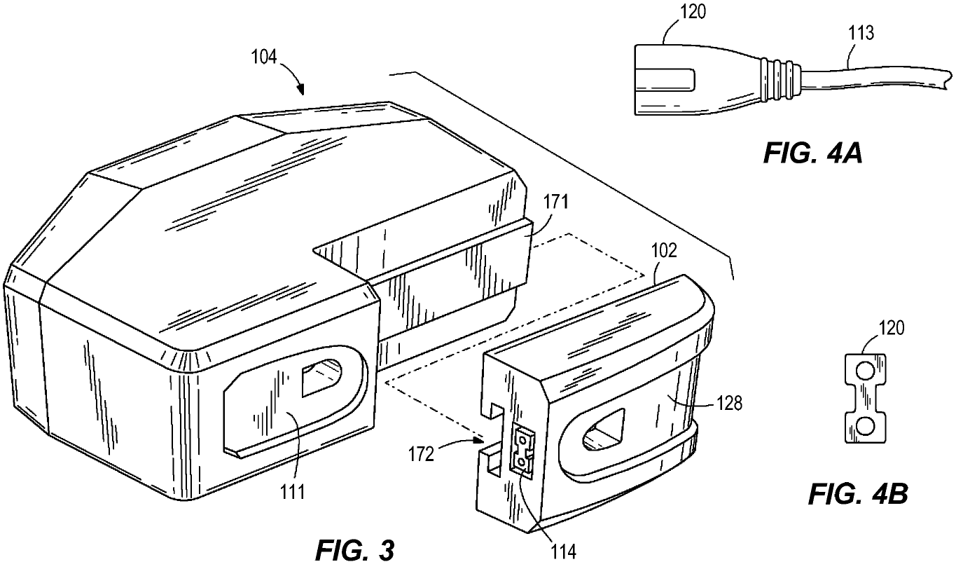

FIGS. 3-6 depict an exemplary audio housing 104, battery charger housing 102, and cord 113. The battery charger housing 102 can be mechanically coupled to the audio housing 104 so as to provide a secure and stable joining of the two housings. The battery charger housing 102, shown without the battery 118, includes a T-shaped slot 172 to engage a T-shaped protrusion 171 on the audio housing 104. The battery charger housing 102 is slid into a locked position by engaging the T-shaped slot with the T-shaped protrusion. The locked position may be achieved by a friction-fitting of a closely paired T-shaped slot and protrusion, by a locking tab, or by another suitable engagement technique. In some instances, the plug 114 and socket 116 secure the battery charger housing 102 to the audio housing 104 without relying on additional mechanical coupling techniques.

FIGS. 4A-B depict two views of an exemplary cord 113. Cord 113 includes plug 120 for engaging the socket 122 or, if the battery charger housing 102 is not connected to the audio housing 104, for engaging the socket 116 (not shown in FIGS. 3-6).

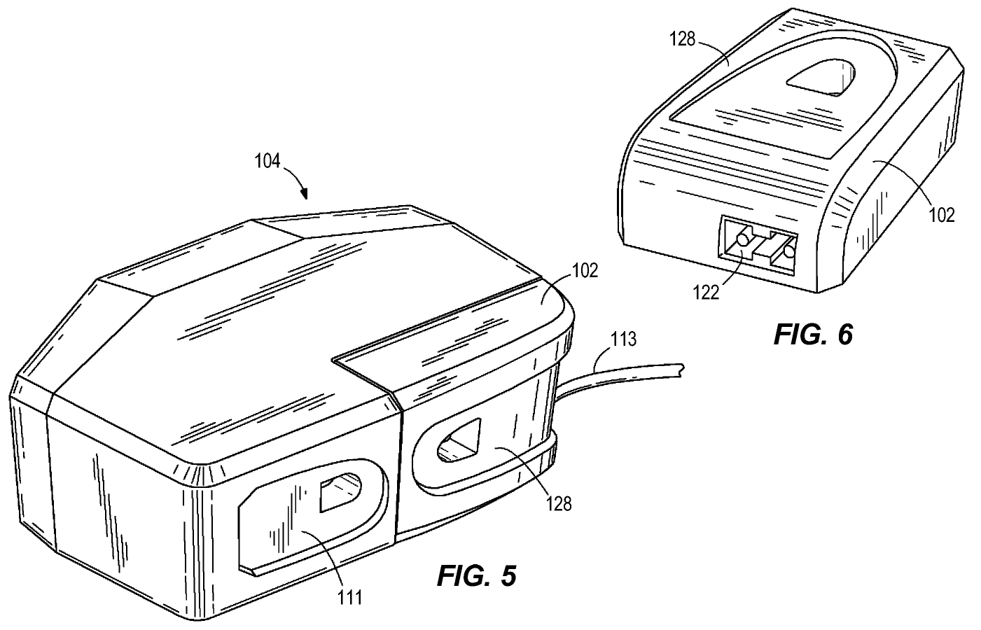

FIG. 5 depicts battery charger housing 102 engaged with the audio housing 104. The cord 113 is connected to the battery charger housing 102. FIG. 6 depicts the battery charger housing 102 with socket 122, which connects to cord 113 via plug 120.

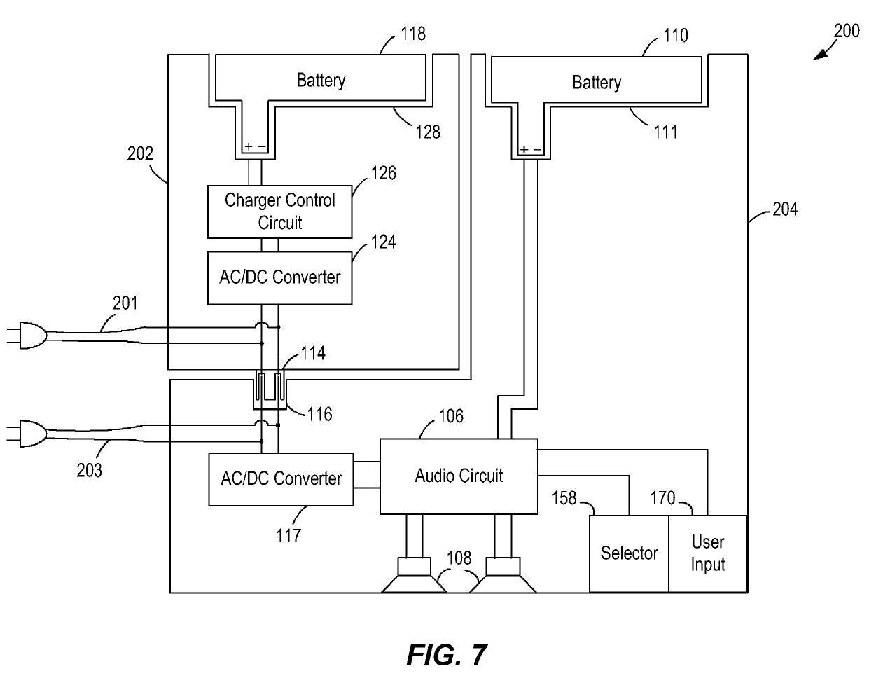

FIG. 7 depicts an audio system 200 according to another embodiment of the invention. The audio system 200 is similar to the audio system 100. However, a cord 201 is fixed to the battery charger housing 202, in contrast to the removable cord 113. Also, a cord 203 is fixed to the audio housing 204, in contrast to the removable cord 130. In some embodiments, when the battery charger housing 202 is coupled to the audio housing 204 via plug 114 and socket 116, the fixed cord 203 is hidden from view.

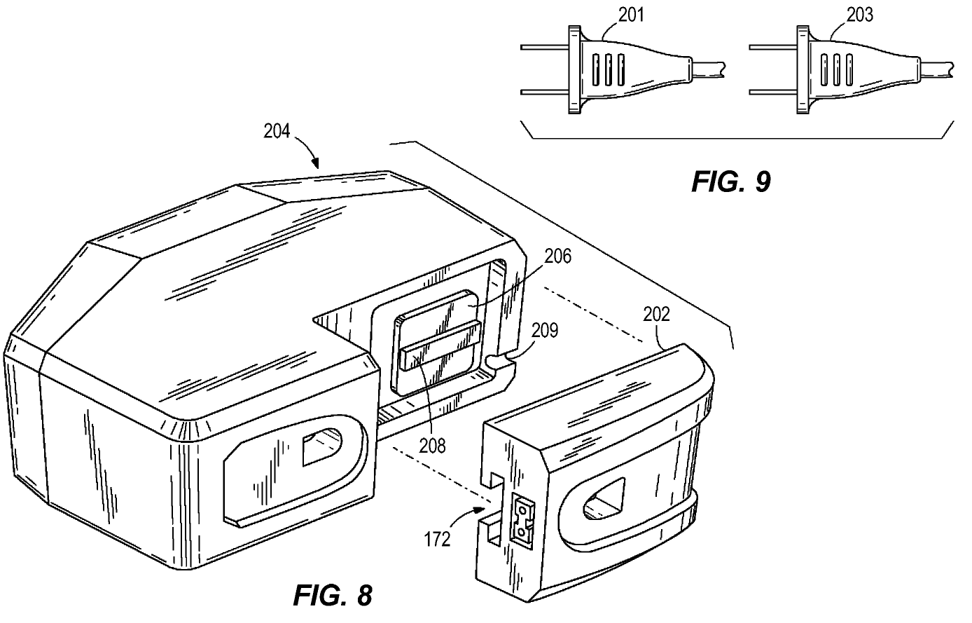

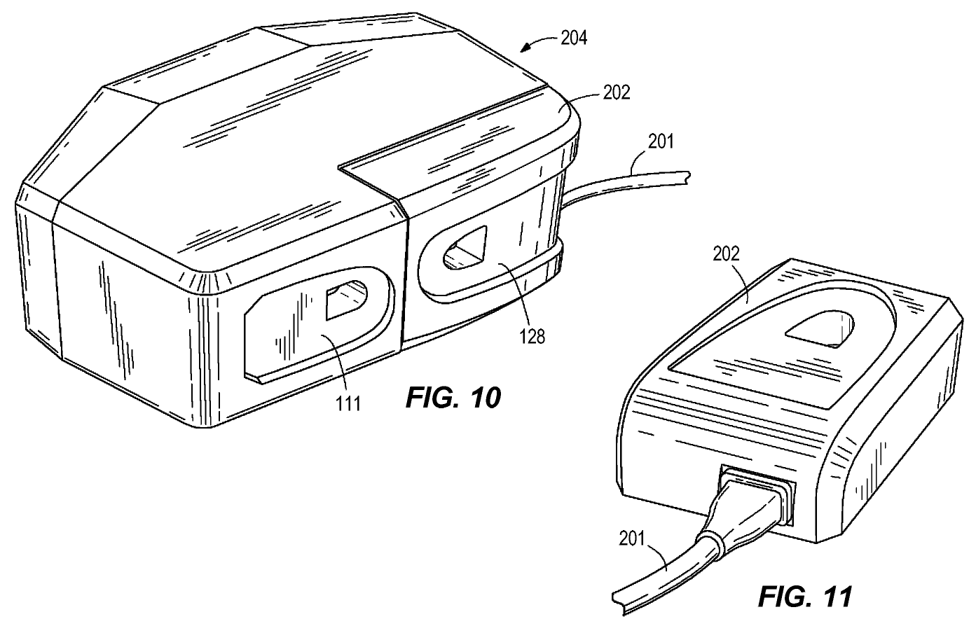

For instance, a cord wrap device 206 can be included on the audio housing 204, as depicted in FIG. 8. Before attaching the battery charger housing 202 to the audio housing 204 by sliding the T-shaped slot 172 onto the T-shaped protrusion 208, the cord 203 can be wrapped around the cord wrap device 206. Upon securing the battery charger housing 202 to the audio housing 204, the cord 203 is hidden from view. In this situation, when the battery charger housing 202 is connected to the audio housing 204, the cord 201 can be used to supply power to both the AC/DC converter 123 and the audio circuit 106. However, when the battery charger housing 202 is removed from the audio housing 204, the cord 203 can be used to couple the audio housing 204 to an external power source and the cord 201 can be used to couple the battery charger housing 202 to an external power source. In other words, the audio housing 204 and battery charger housing 202 can be used together or independently. FIG. 9 depicts the plug ends of the fixed cords 201 and 203. FIG. 10 depicts the audio housing 204 and battery charger housing 202 coupled. The fixed cord 201 is visible, while the fixed cord 203 is wrapped around cord wrap device 206 and hidden from view. FIG. 11 depicts the battery charger 202 with fixed cord 201.

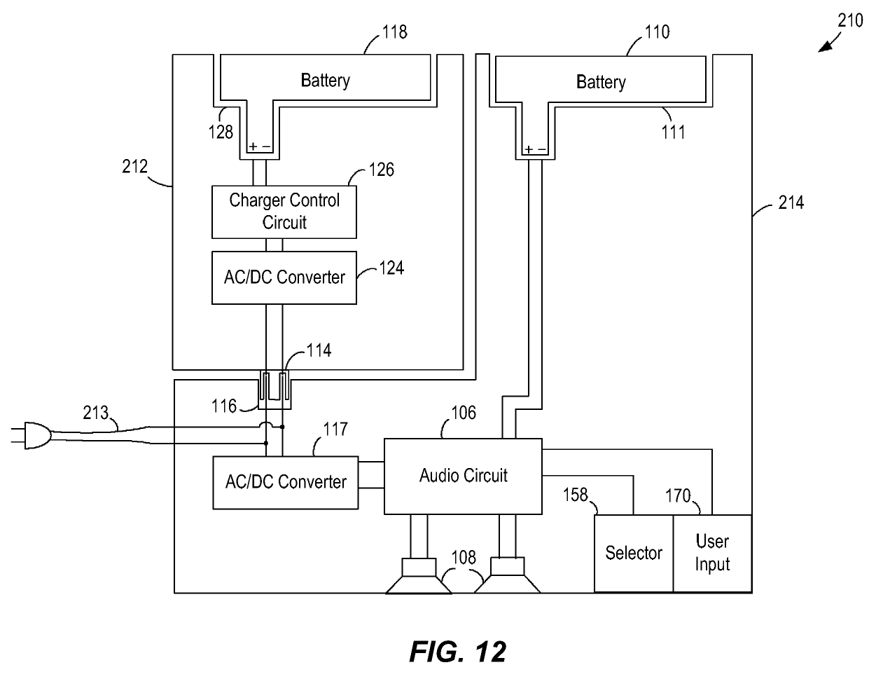

FIG. 12 depicts an audio system 210 according to another embodiment of the invention. The audio system 210 is similar to the audio system 200, except that only one fixed cord 213 is provided. The battery charger housing 212 has no separate cord, but rather, receives power through socket 116 and plug 114. The fixed cord 213 is fed through a slot 209 (see FIG. 8) of the audio housing 204 such that fixed cord 213 can be plugged into a wall outlet even when the battery charger housing 202 is coupled to the audio housing 204.

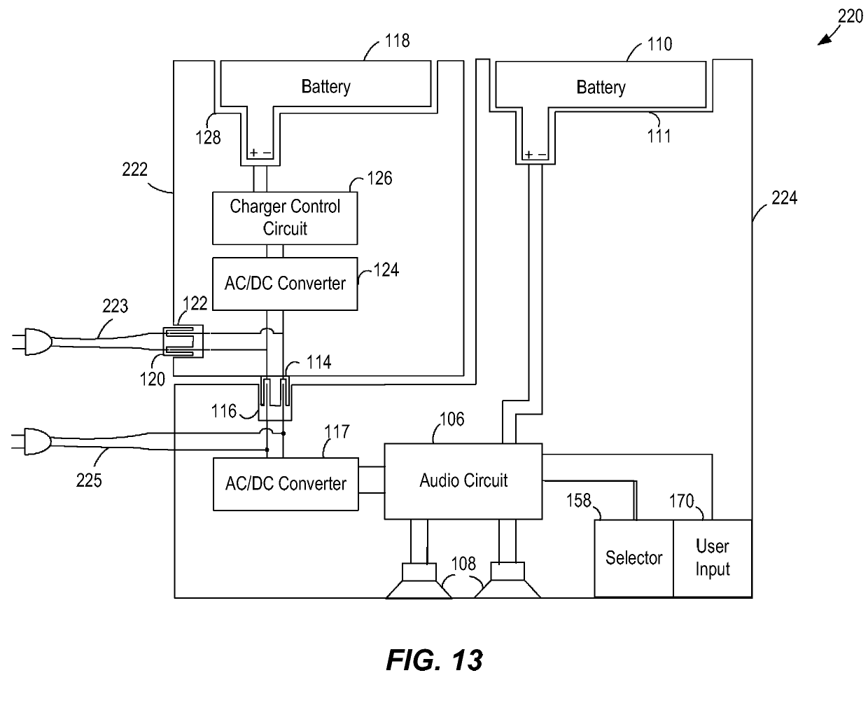

FIG. 13 depicts an audio system 220 according to another embodiment of the invention. The audio system 220 is similar to the audio system 200, except that the audio system 220 includes a removable cord 223 for battery charger housing 222 and a fixed cord 225 for the audio housing 224. The fixed cord 225 is intended for use when the battery charger housing 222 is separated from the audio housing 224. When the battery charger housing 222 is attached to the audio housing 224, the fixed cord 225 is hidden from view using a cord wrap device and cord 223 is connected to the external power source.

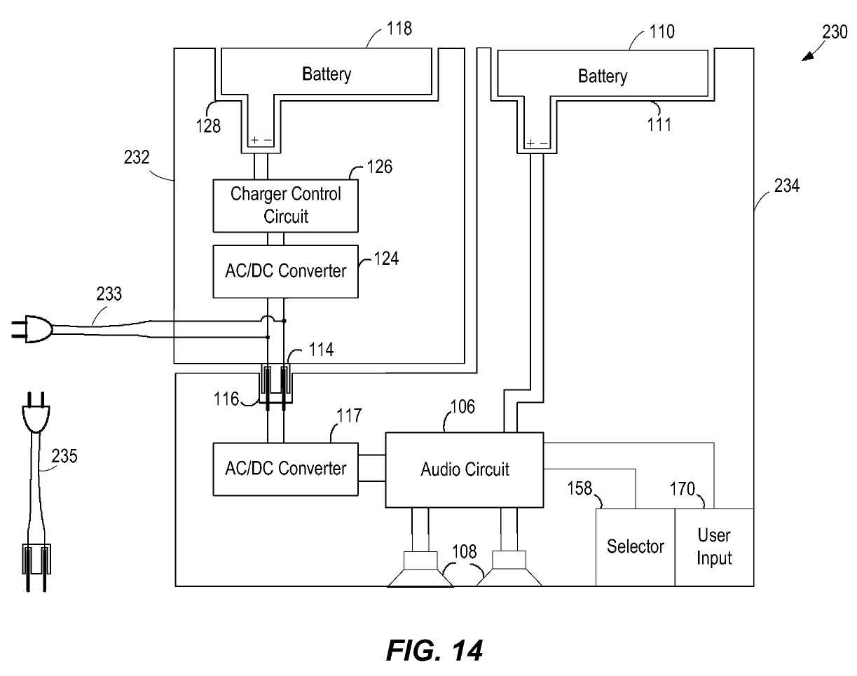

FIG. 14 depicts an audio system 230 according to another embodiment of the invention. The audio system 230 is similar to the audio system 200, except that the audio system 230 includes a removable cord 235 for plugging into the audio housing 234 when the battery charger housing 232 is not coupled to the audio housing 234. Additionally, the battery charger housing 232 includes a fixed cord 233. Thus, the battery charger housing 232 can charge a battery when the battery charger housing 232 is separated from the audio housing 234. In some embodiments, the audio housing 234 and audio housing 104 include a cord wrap device similar to cord wrap device 206 of FIG. 8.

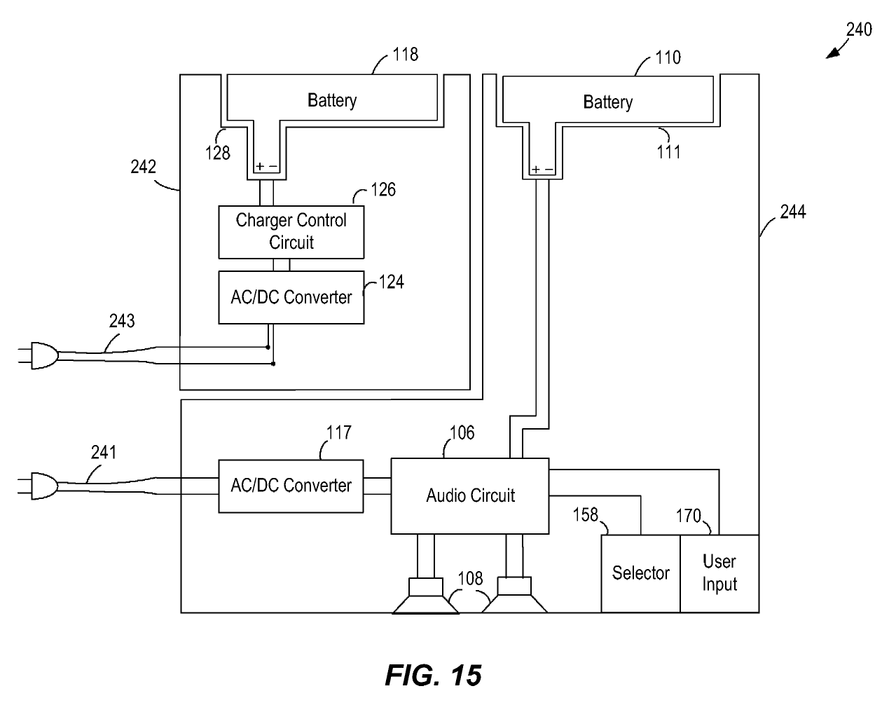

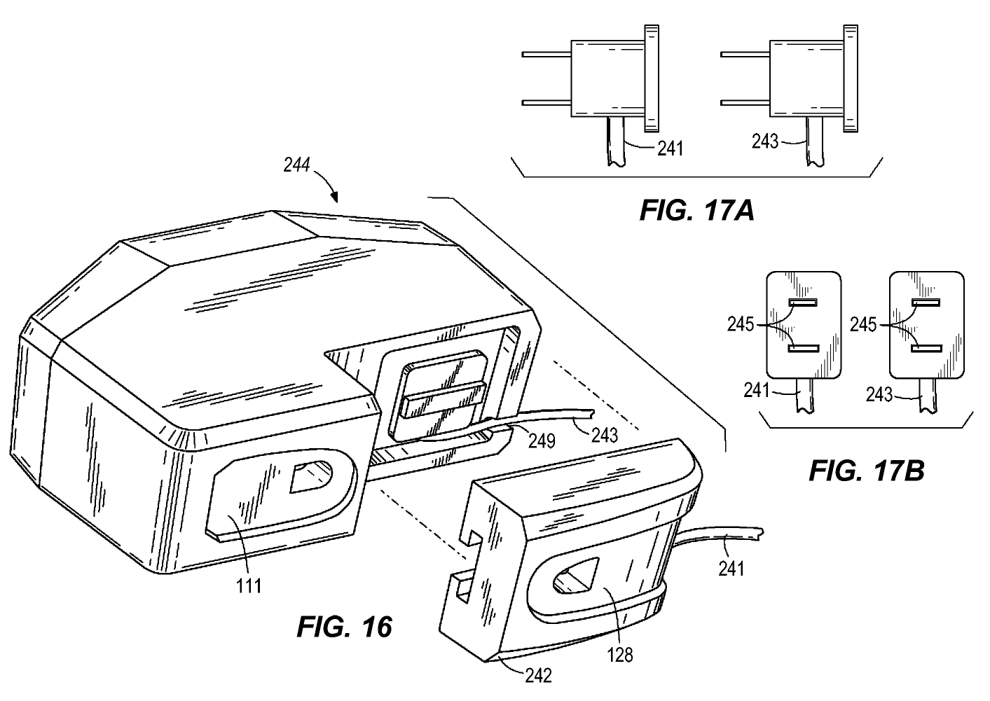

FIG. 15 depicts an audio system 240 according to another embodiment of the invention. The audio system 240 is similar to the audio system 200 except that the audio housing 244 and battery charger housing 242 each have respective fixed cords 243 and 241, and the battery charger housing 242 and audio housing 244 are not electrically coupled by a socket and plug combination on the housings. In some embodiments, the cords 241 and 243 are similar to cords 201 and 203 of FIG. 9. In other embodiments, the cords 241 and 243 have an interlocking arrangement as depicted in FIGS. 17A-B. In the interlocking arrangement, the cord 241 may engage a wall outlet, and the cord 243 may engage the back of the cord 241 via slots 245, or vice versa. Thus, only one wall outlet socket is needed for two cords in the interlocking arrangement. In some embodiments, only one cord (e.g., cord 241) has an interlocking capable back, while the other cord (e.g., cord 243) is similar to cord 201 or 203 of FIG. 9. As depicted in FIG. 16, the audio housing 244 includes a slot 249 through which the cord 243 can be fed even when the battery charger housing 242 is coupled to the audio housing 244.

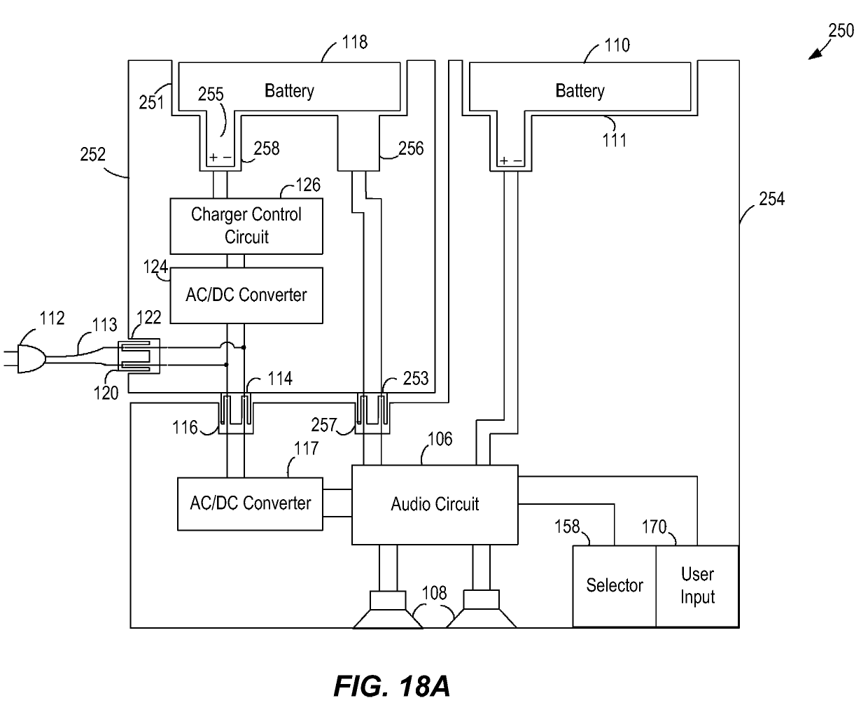

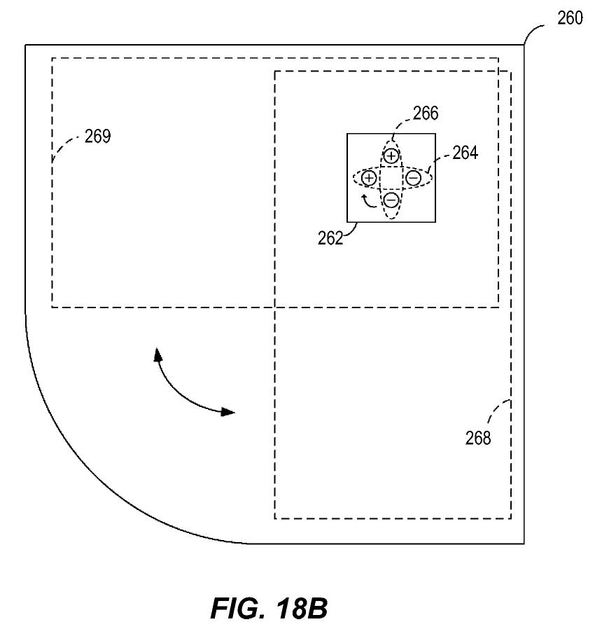

FIG. 18A depicts an audio system 250 with a battery charger housing 252 and an audio housing 254 according to another embodiment of the invention. The audio system 250 includes a removable cord similar to the audio system 100 depicted in FIG. 1. However, the audio system 250 includes a two-position battery receptacle 251, a plug 253, a socket 257 for receiving plug 253, and battery sockets 256 and 258. In a first position, a battery connector 255 of the battery 118 is inserted into the battery socket 258. When the battery 118 is placed in battery receptacle 251 in the first position as depicted in FIG. 18A, the audio system 250 functions the same as the audio system 100. In other words, the battery 118 can be charged, but does not provide power to the audio circuit 106. In contrast to the audio system 100, the battery 118 can be placed in a second position. In the second position, the battery connector 255 is placed within a battery socket 256. In the second position, the battery 118 provides power to the audio circuit 106, but is not charged. The audio circuit 106 can either select one of the batteries 118 or 110 to provide power or combine the power from both batteries 118 and 110 for simultaneous use.

In some embodiments, a two-position battery receptacle 260 is provided as shown in FIG. 18B. Battery receptacle 260 includes one battery socket 262 that enables switching positions simply by rotating the battery 118. For instance, in one embodiment, rotating the battery 118 by 90 degrees breaks the electrical connection to the charger control circuit 126 and electrically connects the battery 118 to the audio circuit 106 shown in FIG. 18A. The effect of rotating the battery 118 is similar in function to switching the battery 118 from the first position and second position of battery receptacle 251. Rotating the battery 118 back 90 degrees will switch the battery 118 from the second to the first position. In one embodiment, four electrical contacts are provided in the battery socket 262. Two of the electrical contacts of the battery socket 262 align with two electrical contacts of the battery 118 in the first position 264. The other two electrical contacts of the battery socket 262 align with the two electrical contacts of the battery 118 in the second position 266. The dashed boxes 268 and 269 indicate the approximate location of the battery 118 in the first and second positions, respectively. Various degrees of rotation can be used to switch between the first and second positions in other embodiments.

In some embodiments of the audio system 250 with a two-position battery receptacle 251 or 260, the battery 110 and battery receptacle 111 are not provided. Any of the cord arrangements (i.e., fixed cords, removable cords, or a combination thereof) described in relation to audio systems 200, 210, 220, 230, and 240 may be implemented on audio system 250. In some embodiments of audio housings 104, 204, 214, 224, 234, 244, and 254, multiple battery receptacles are provided and the power control 156 operates to select one or a combination of the batteries to supply power to the components of the audio circuit 106. In some embodiments of the audio systems 100, 200, 210, 220, 230, 240, and 250, the external power source is a DC source, such as a 12 volt car battery, and the AC/DC converters of the audio systems are bypassed.

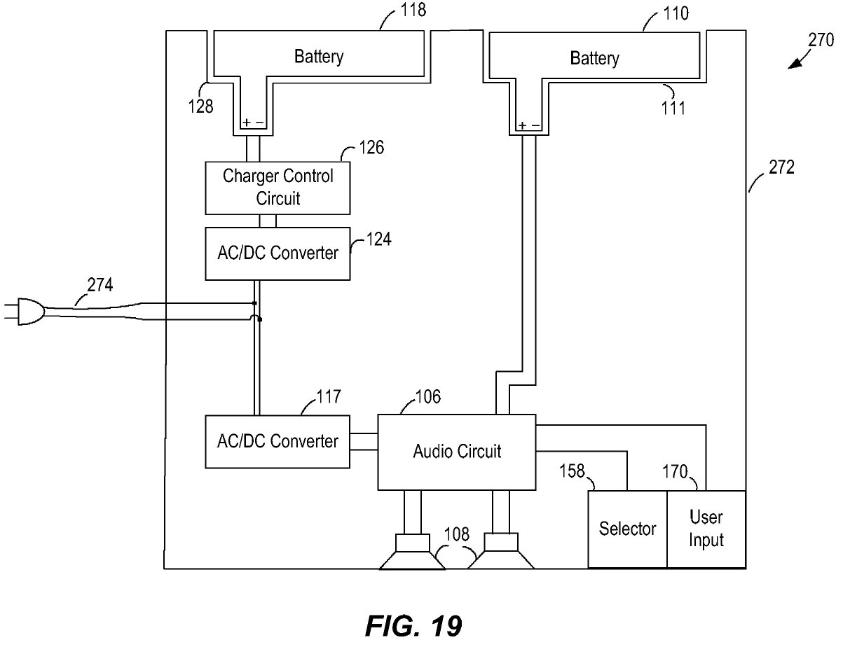

FIG. 19 depicts an audio system 270 according to another embodiment of the invention. The audio system 270 is similar to the audio system 230 except that a single integrated audio and battery charger housing 272 is implemented in place of two independent housings. Thus, only a single cord 274 is attached to the audio and battery charger housing 272. In the embodiment shown, the cord 274 is fixed to the audio and battery charger housing 272; however, the cord 274 is removable in other embodiments. Furthermore, in some embodiments, a separate cord (not shown) is coupled to the audio circuit 106 via AC/DC converter 117 and the cord 274 is coupled to the charger control circuit via the AC/DC converter 124. Thus, the audio circuit 106 and charger control circuit 126 each have separate connections to one or more external power sources.

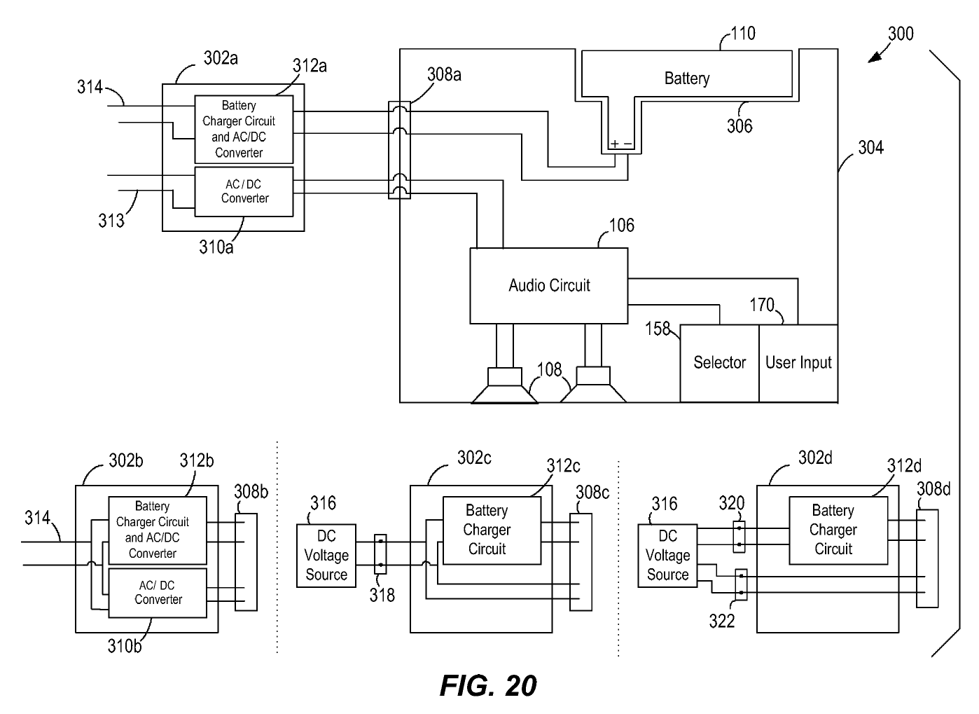

FIG. 20 depicts an audio system 300 according to another embodiment of the invention. The audio system 300 includes a transformer box 302a and an audio housing 304. Within the audio housing 304 is a battery receptacle 306 that receives the rechargeable battery 110, the audio circuit 106, the selector 158, the user input 170, and the speakers 108.

The transformer box 302a couples the audio circuit 106 and the battery 110 to an external power source via a wall outlet. Within the transformer box is an AC/DC converter 310a to connect to the audio circuit 106, and also a battery charger circuit and AC/DC converter 312a to connect to the battery 110. The transformer box 302a includes two prong sets 313 and 314 for engaging two outlets of an AC power outlet fixture (not shown).

In some embodiments, the transformer box 302a is attached to the audio housing 304 at connector 308a by a fixed cord. In other embodiments, the transformer box 302a is removably attached to the audio housing 304 at connector 308a by a removable cord.

Alternative transformer boxes 302b-d are also shown in FIG. 20. Transformer box 302b is similar to transformer box 302a except that only a single prong set 314 is provided. The single prong set 314 engages one outlet of an AC power outlet fixture (not shown). The battery charger circuit and AC/DC converter 312b, AC/DC converter 310b, and connector 308b function similarly to their counterparts of transformer box 302a.

Transformer box 302c is connected to a DC voltage source 316 by a single connector 318. Since the transformer box 302c receives DC voltage, no AC/DC conversion is necessary. Thus, the AC/DC converter components of the transformer boxes 302a and 302b are not included in transformer boxes 302c. The transformer box 302c passes the DC voltage to the audio circuit 106 through connector 308c and to the battery charger circuit 312c. The battery charger circuit 312c is then coupled to the battery 110 via connector 308c. In some embodiments, the DC voltage source 316 is a car battery and the connector 318 is a plug adapted to fit into a DC car outlet (commonly referred to as a cigarette lighter receptacle).

Similar to transformer box 302c, transformer box 302d receives DC voltage and, therefore, does not include AC/DC conversion circuitry. In contrast to transformer box 302c, transformer box 302d includes two connectors 320 and 322 for connecting to the DC voltage source 316 separately. For instance, the two connectors 320 and 322 may connect to two different DC car outlets. Through connectors 322 and 308d, the transformer box 302d connects the DC voltage source 316 to the audio circuit 106. The connector 320 connects the DC voltage source 316 to the battery charger circuit 312d, which provides power to the battery 110 via connector 308d.

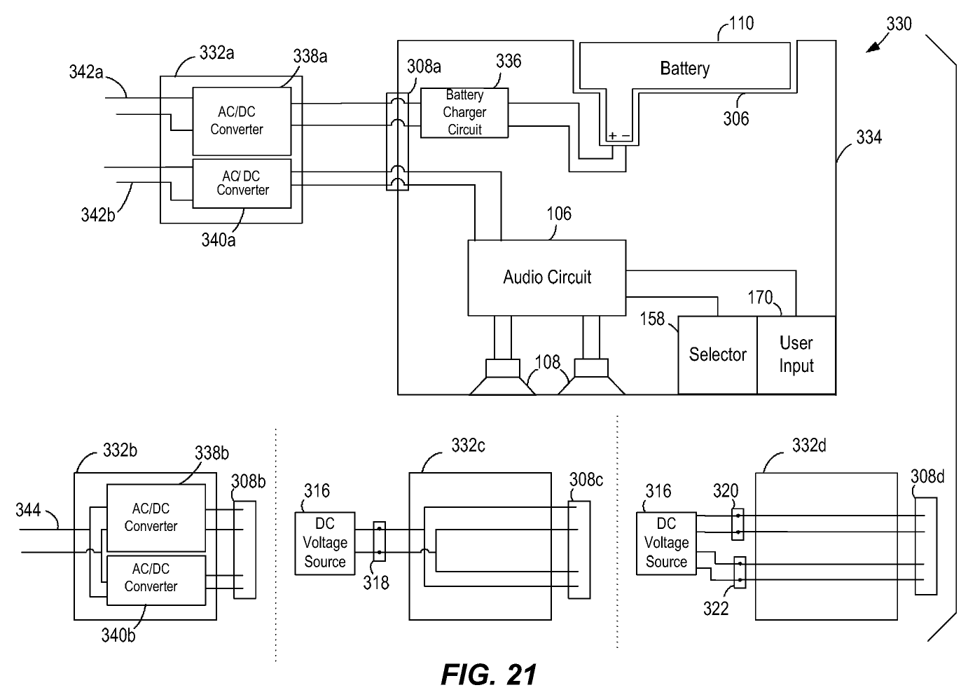

FIG. 21 depicts an audio system 330 with transformer box 332a and audio housing 334. The audio system 330 is similar to audio system 300 except that the battery charger circuit 336 is within the audio housing 334, not a transformer box. The audio system 330 can receive power via transformer box 332a, 332b, 332c, or 332d. The transformer box 332a includes two prong sets 342a and 342b to couple AC/DC converters 338a and 340a to the battery charger circuit 336 and audio circuit 106, respectively. The transformer box 332b includes a single prong set 344 coupled to both the AC/DC converter 338b and AC/DC converter 340b. When the single prong set 344 is connected to an external power source, the AC/DC converter 338b provides DC power to the battery charger circuit 336 and the AC/DC converter 340b provides DC power to the audio circuit 106. The transformer boxes 332c and 332d are essentially DC pass-through circuits that connect to the DC voltage source 316, to provide power to the audio circuit 106 and battery charger circuit 336.

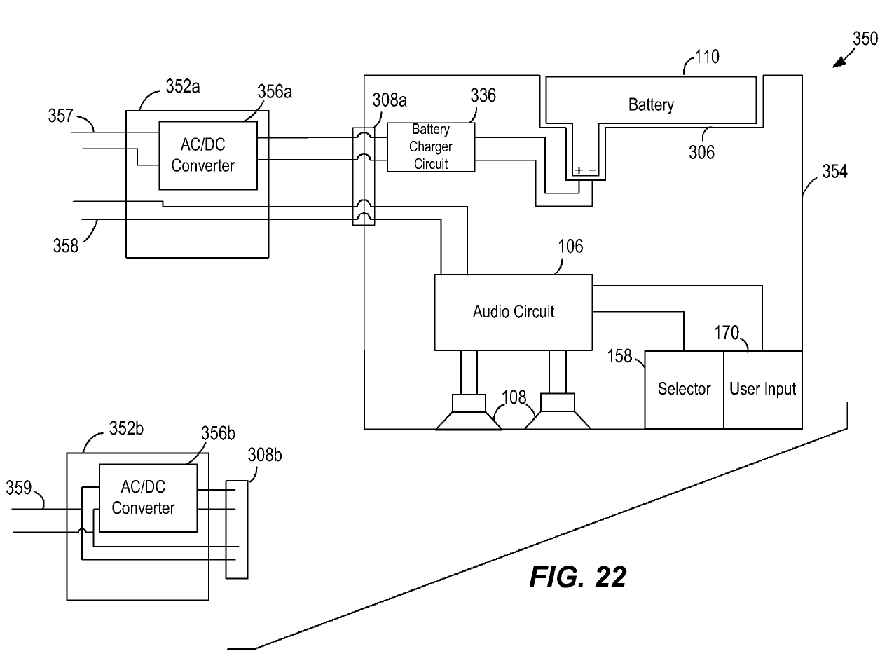

FIG. 22 depicts an audio system 350 with transformer box 352a and audio housing 354. The transformer box 352a includes an AC/DC converter 356a. The AC power provided along prong set 357 is received by the AC/DC converter 356a and output as DC power to the battery charger circuit 336. The AC power provided along prong set 358 is forwarded directly to the audio circuit 106, which includes an AC/DC converter. Alternatively, a single prong set transformer box 352b with prong set 359 and AC/DC converter 356b may be used in place of transformer box 352a.

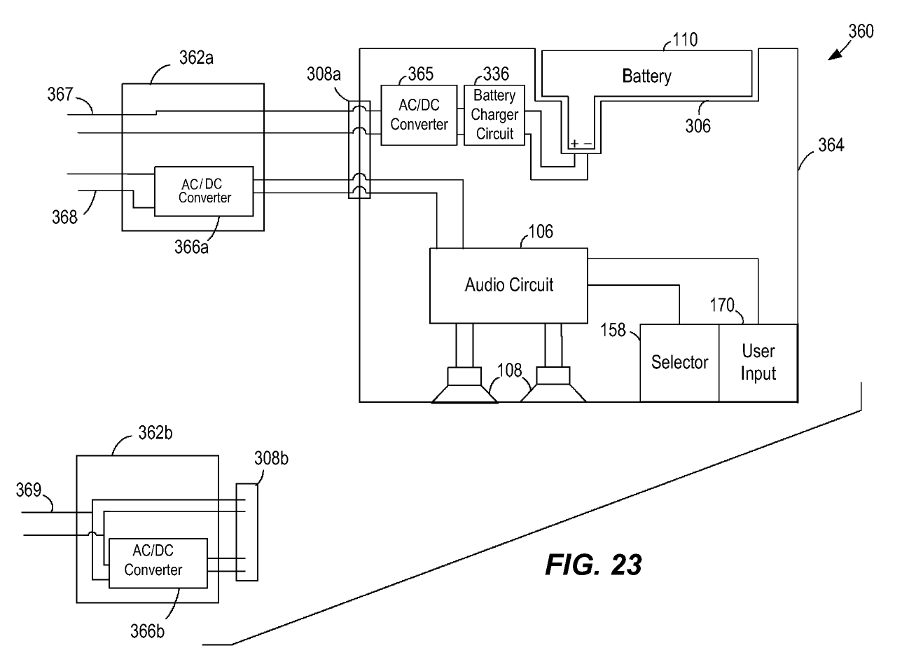

FIG. 23 depicts an audio system 360 with transformer box 362a and audio housing 364. The audio housing 364 is similar to audio housing 354 except that audio housing 364 includes an AC/DC converter 365 and the audio circuit 106 does not include an AC/DC converter. The transformer box 362a includes an AC/DC converter 366a and two prong sets 367 and 368. The AC power provided along prong set 367 is provided directly to AC/DC converter 365 within the audio housing 364. The AC power provided along prong set 368 is converted to DC power by AC/DC converter 366a and output to the audio circuit 106. Alternatively, a single prong set transformer box 362b with prong set 369 and AC/DC converter 366b may be used in place of transformer box 362a.

In some embodiments, the audio housings 304, 334, 354, and 364 include a second battery receptacle (not shown) similar to the battery receptacle 111 of audio system 100. The second battery receptacle is operable to receive the battery 118. The second battery receptacle is electrically connected to the audio circuit 106 and includes electrical contacts. Thus, the second battery receptacle is operable to connect the battery 118 to the audio circuit 106 to provide DC power to the audio circuit 106. The power control 156 selectively couples the second battery to the components of audio circuit 106 as described above with respect to other embodiments.

In some embodiments, the battery receptacle 306 is a two-position receptacle similar to battery receptacle 251 and 260 of FIGS. 18A-B. That is, the battery 118 is operable to receive power from a charging circuit in the first position and operable to power the audio circuit when in the second position. In other embodiments, the battery receptacle 306 includes a two-position receptacle whereby the battery 110 switches between a first and second position by rotation as described above.

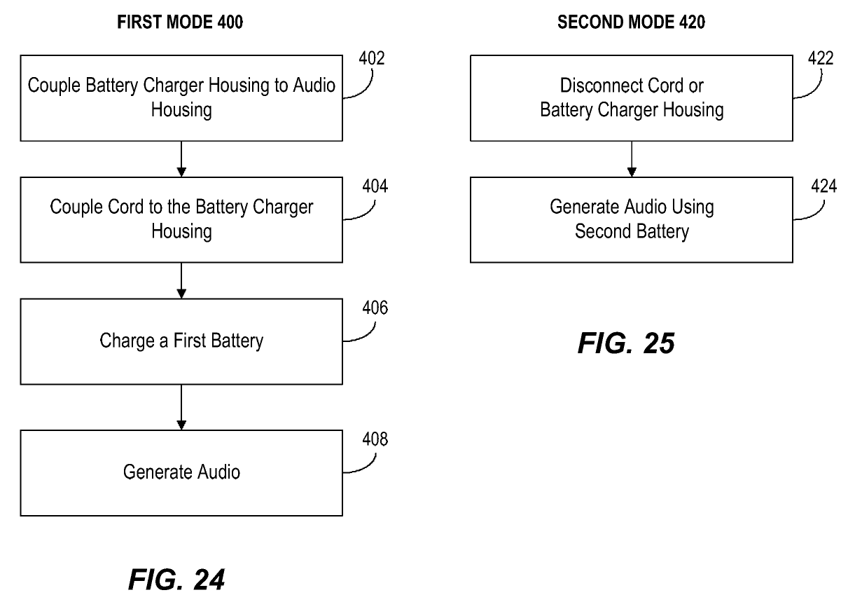

FIGS. 24-27 depict four modes of operating one or more of the above described audio systems. For illustration, the modes will be discussed in relation to audio system 250 of FIGS. 18A-B. However, the modes of operation are also applicable to other audio systems described above.

FIG. 24 depicts a first mode 400 of operating the audio system 250. In step 402, the battery charger housing 252 is coupled to the audio housing 254, for instance, by connecting plugs 114 and 253 with sockets 116 and 257. In step 404, the cord 113 is coupled to the battery charger housing 252 using plug 122 and to an external power source using plug 112. Once the connections are made, in step 406, the battery 118 within battery receptacle 251 is charged using the charger control circuit 126. In step 408, the audio circuit 106 and speakers 108 generate audio. The external power source provides power for charging the battery 118 in step 406 and generating audio in step 408. In some embodiments, steps 406 and 408 occur simultaneously. In other embodiments, steps 406 and 408 occur consecutively, simultaneously, and/or a combination thereof, depending on the status of the selector 158 and user input 170. Similarly, the order of steps 402 and 404 is alterable such that step 404 may occur before or simultaneously with step 402.

FIG. 25 depicts a second mode 420 of operating the audio system 250. In step 422, the battery charger housing 252 is disconnected from the audio housing 254 or the cord 113 is disconnected from the battery charger housing 252. Thus, in either instance, the audio housing 254 is no longer coupled to the external power source. In step 424, the audio circuit 106 and speakers 108 generate audio using power from battery 110 in the battery receptacle 111.

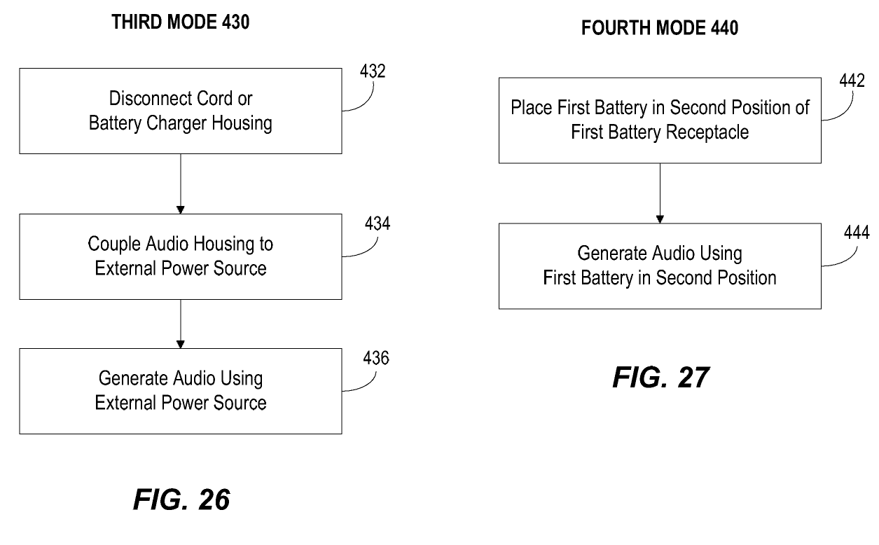

FIG. 26 depicts a third mode 430 of operating the audio system 250. In step 432, the battery charger housing 252 is disconnected from the audio housing 254. In step 434, the audio housing 254 is coupled to the external power source or to a different external power source (e.g., if the audio system 250 is transported to a different location) by coupling cord 113 to socket 116. In step 436, the audio circuit 106 and speakers 108 generate audio using power from the external power source or the different external power source. The particular implementation of steps 432 and 434 may vary depending on the audio system in operation. For instance, in audio system 200, either the battery charger housing 202 is removed or the plug 201 is disconnected in step 432. In step 434, the cord 203 is coupled to the external power source or a different external power source. Regardless of the audio system, the result of step 432 and 434 is that the audio housing will no longer receive power through a battery charger housing and pass through circuit. Rather, a connection between an external power source and the audio housing will exist via a cord connected to the audio housing.

FIG. 27 depicts a fourth mode 440 of operating the audio system 250. In step 442, the battery 118 is switched from the first position 258 to the second position 256. In step 444, the audio circuit 106 and speakers 108 generate audio using power from battery 118 in the second position 256 of battery receptacle 251. The fourth mode applies to those audio systems that include two-position battery receptacles, such as the two-position battery receptacles depicted in FIGS. 18A and 18B.

In some embodiments, the battery chargers described above are operable to charge any of a plurality of different types of batteries or battery packs. For example, the battery chargers are capable of charging battery packs having any number of different voltage ratings, capacity ratings, configurations, shapes, and sizes. Such battery packs include those that are attachable to and detachable from electrical devices such as power tools, test and measurement equipment, vacuum cleaners, outdoor power equipment, and vehicles. Power tools include, for example, drills, circular saws, jig saws, band saws, reciprocating saws, screw drivers, angle grinders, straight grinders, hammers, impact wrenches, angle drills, inspection cameras, and the like. Test and measurement equipment includes digital multimeters, clamp meters, fork meters, wall scanners, IR temperature guns, and the like. Vacuum cleaners include stick vacuums, hand vacuums, upright vacuums, carpet cleaners, hard-surface cleaners, canister vacuums, broom vacuums, and the like. Outdoor power equipment includes blowers, chain saws, edgers, hedge trimmers, lawn mowers, trimmers, and the like.

In some embodiments, the battery charger housings 102, 202, 212, 222, 232, 242, and 252 are also able to be coupled to non-audio generating devices. For example, in some embodiments, the battery chargers 102, 202, 212, 222, 232, 242, and 252 are attachable to and detachable from the electrical devices listed above including power tools, test and measurement equipment, vacuum cleaners, outdoor power equipment, and vehicles.

Thus, the invention provides, among other things, audio devices powerable by rechargeable batteries or an external power source. Additionally, the audio devices include a separate battery charging housing or separate battery charging circuit. A separately attachable battery charger presents a user with options for using the audio device alone, battery charger alone, or attaching the audio device and battery charger together for simultaneous use. Thus, if only one of the two devices is desired, a user can carry the single device, which weighs less than the combination of the two devices. As the battery charger and audio device have independent circuits, upon a malfunction of one component (e.g., the battery charger), a replacement component can be purchased without the need for replacing the entire system, which reduces waste and replacement costs.

Additionally, many embodiments provide multiple battery receptacles allowing the charging of one battery while another battery provides power or is stored in a position to provide power upon disconnection of the audio device from an external power source. Thus, in some embodiments, multiple batteries and a battery charger can be secured to the audio device for ease of transport of the audio device, battery charger, and batteries. Moreover, the battery charger is modular and, with battery charger attachments incorporated onto multiple devices (e.g., radio, vacuum, or lawn care products), the user is provided multiple product options for attaching to the battery charger. Various additional features and advantages of the invention are set forth in the following claims.

What is claimed is:

1. An audio system comprising:
a battery charger housing including a charger control circuit and a first battery receptacle having a first battery position, wherein the charger control circuit is electrically coupled to the first battery receptacle and is operable to charge a battery in the first battery position within the first battery receptacle;
an audio device housing including an audio circuit and a second battery receptacle, wherein the audio circuit is electrically coupled to the second battery receptacle and operable to generate sound using at least one audio generator; and
a pass-through circuit electrically coupled to the audio circuit and the charger control circuit, wherein the pass-through circuit is operable to receive power from an external source, provide the power to the charger control circuit, and provide the power to the audio circuit,
wherein the battery charger housing and the audio device housing are selectively engageable.

2. The audio system of claim 1, wherein the audio circuit is operable to selectively receive the power from the external source and battery power from a second battery within the second battery receptacle.

3. The audio system of claim 1,
wherein the pass-through circuit is operable to receive the power from the external source via a first cord connected to the battery charger housing when the battery charger housing and the audio device housing are selectively engaged, and
wherein the audio circuit is operable to receive the power from the external source via one of the first cord and a second cord connected to the audio device housing when the battery charger housing and the audio device housing are not selectively engaged.

4. The audio system of claim 3, wherein the first cord and the second cord are connectable to the audio device housing and the battery charger housing male-female connectors.

5. The audio system of claim 1, wherein the pass-through circuit includes a male-female connection between the audio device housing and the battery charger housing.

6. The audio system of claim 1, wherein the at least one audio generator is operable to generate the sound using at least one of a tape, a compact disc, a digital data file, and received radio waves.

7. The audio system of claim 1, wherein the first battery receptacle has a second battery position, wherein a battery in the second battery position is operable to provide power to the audio circuit.

8. The audio system of claim 1, wherein the battery is a power tool battery and is operable to be received by and provide power to a power tool.

9. An audio system comprising:
a battery charger housing including a charger control circuit and a first battery receptacle operable to receive a first removable battery, wherein the charger control circuit is electrically coupled to the first battery receptacle to charge the first battery when in a first battery position within the first battery receptacle; and
an audio device housing including an audio circuit and a second battery receptacle, wherein the audio circuit is electrically coupled to the second battery receptacle and is operable to generate sound using at least one audio generator,
wherein the audio circuit is operable to at least one of combine and selectively apply power received from a second removable battery within the second battery receptacle and power received from an external power source to the at least one audio generator, and
wherein the battery charger housing and the audio device housing are selectively engageable.

10. The audio system of claim 9,
wherein the charger control circuit and the audio circuit are operable to receive the power from the external power source via a first cord connected to the battery charger housing when the battery charger housing and the audio device housing are engaged, and
wherein the audio circuit is operable to receive the power from the external power source via one of the first cord and a second cord connected to the audio device housing when the battery charger housing and the audio device housing are not engaged.

11. The audio system of claim 10, wherein the first cord and the second cord are interchangeable and selectively removable from the battery charger housing and audio device housing.

12. The audio system of claim 9, wherein the audio device housing and the battery charger housing are engageable using a male-female connection.

13. The audio system of claim 12, wherein a cord is connectable to the audio device housing an audio device housing portion of the male-female connection when the audio device housing and the battery charger housing are not engaged.

14. The audio system of claim 9, wherein the at least one audio generator is operable to generate the sound using at least one of a tape, a compact disc, a digital data file, and received radio waves.

15. The audio system of claim 9, wherein the first removable battery is positionable into a second battery position within the first battery receptacle, wherein the first removable battery in the second battery position is operable to provide power to the audio circuit.

16. The audio system of claim 9, wherein the first removable battery is a power tool battery and is operable to be received by and provide power to a power tool.

17. An audio system comprising:
a battery charger housing including a charger control circuit and a first battery receptacle, wherein the charger control circuit is coupled to a first electrical connection in the first battery receptacle and is operable to charge a first removable battery in a first battery position; and
an audio device housing engageable with the battery charger housing and including an audio circuit and a second battery receptacle, wherein the audio circuit is electrically coupled to the second battery receptacle and operable to generate sound using at least one audio generator;
wherein the audio circuit is operable to selectively couple the at least one audio generator to the second battery receptacle and an input configured to receive power from an external source; and
wherein when the battery charger housing is engaged with the audio device housing and the power is received at the input from the external source, the charger control circuit and the audio circuit share the power received from the external source.

18. The audio system of claim 17, wherein the audio circuit is operable to receive the power from the external source via a first cord connected to the audio device housing when the battery charger housing and the audio device housing are not engaged.

19. The audio system of claim 17, wherein the audio device housing and the battery charger housing connect using a male-female electrical connection.

20. The audio system of claim 19, wherein a cord is connectable to the audio device housing an audio device housing portion of the male-female electrical connection when the audio device housing and the battery charger housing are not engaged.

21. The audio system of claim 17, wherein the at least one audio generator is operable to generate the sound using at least one of a tape, a compact disc, a digital data file, and received radio waves.

22. The audio system of claim 17, wherein the first removable battery is positionable into a second battery position on the audio device housing, wherein the first removable battery in the second battery position is operable to provide power to the audio circuit.

23. The audio system of claim 17, wherein the first removable battery is a power tool battery and is operable to be received by and provide power to a power tool.

24. A method of charging a battery and generating audio comprising:
operating an audio housing in a first mode, wherein the first mode includes
coupling a battery charger housing to the audio housing, wherein the battery charger housing includes a first battery receptacle and a charging circuit and the audio housing includes an audio generating circuit and a second battery receptacle;
coupling the battery charger housing to an external power source using a cord such that an electrical connection is formed between the external power source, the charging circuit, and the audio generating circuit;
charging a first battery in a first position in the first battery receptacle; and
generating audio using the audio generating circuit powered by the external power source; and
operating the audio housing in at least one of a second mode and a third mode,
wherein the second mode includes
disconnecting at least one of the cord from the battery charger housing and the battery charger housing from the audio housing; and
generating audio using the audio generating circuit powered by a second battery in the second battery receptacle; and
wherein the third mode includes
disconnecting at least one of the cord from the battery charger housing and the battery charger housing from the audio housing;
coupling the external power source or a different external power source to the audio housing; and
generating audio using the audio generating circuit powered by the external power source or the different external power source.

25. The method of claim 24, wherein the cord is selectively removable and, in the third mode, coupling the external power source or a different external power source to the audio housing includes coupling the cord.

26. The method of claim 24, wherein in the third mode, coupling the external power source or a different external power source to the audio housing includes coupling a fixed cord of the audio housing to the external power source or the different external power source.

27. The method of claim 26, wherein the cord is fixed to the battery charger housing.

28. The method of claim 24, further comprising operating the audio housing in a fourth mode, wherein the fourth mode includes
placing the first battery in a second position within the first battery receptacle, and
generating audio using the audio generating circuit powered by the first battery in the second position.

29. The method of claim 24, wherein the first battery is a power tool battery and is operable to be received by and provide power to a power tool.
